(19) United States
(12) Patent Application Publication
(10) Pub. No.: US 2024/0258091 A1
(43) Pub. Date: Aug. 1, 2024

(54) Enhanced Q1 Mass Segregation in Scanning SWATH

(71) Applicant: DH TECHNOLOGIES DEVELOPMENT PTE. LTD., Singapore (SG)

(72) Inventor: Stephen A. Tate, Barrie (CA)

(21) Appl. No.: 18/566,642

(22) PCT Filed: Jun. 2, 2022
(86) PCT No.: PCT/IB2022/055172

§ 371 Date: Dec. 2, 2023

Related U.S. Application Data
(60) Provisional application No. 63/208,538, filed on Jun. 9, 2021.

(51) Int. Cl. H01J 49/00

(52) U.S. Cl. CPC H01J 49/0031; H01J 49/0045

(57) ABSTRACT

During each time cycle, a precursor ion transmission window is stepped in k overlapping steps that are Δm m/z apart entirely across a mass range from a starting mₗm/z. The window is stepped n−1 more times starting at n−1 different offsets from mₗ between mₗ and mₗ+Δm. A total of n scans of the mass range. A total of k×n product ion spectra are produced that are a function of precursor ion m/z for each time cycle. A product ion is selected from the spectra. For at least one time cycle, an intensity of the product ion as a function of precursor ion m/z is reconstructed with a resolving power greater than Δm by combining intensities of the product ion measured during each of the n scans using a linear reconstruction algorithm, such as Drizzle.

### RELATED APPLICATIONS

This application claims the benefit of U.S. Provisional Patent Application Ser. No. 63/208,538, filed on Jun. 9, 2021, the content of which is incorporated by reference herein in its entirety.

### INTRODUCTION

The teachings herein relate to increasing the resolution of a scanning SWATH tandem mass spectrometry method. More particularly the teachings herein relate to systems and methods for operating a mass spectrometer to produce multiple scans of the precursor ion mass range with different offsets or shifts. The measured product ion intensity measurements from the multiple scans are used as input to a linear reconstruction algorithm to increase the resolution of the measured product ion intensity data in the precursor ion mass-to-charge ratio (m/z) dimension.

The systems and methods herein can be performed in conjunction with a processor, controller, or computer system, such as the computer system of FIG. 1.

### BACKGROUND

As described below, scanning SWATH is a tandem mass spectrometry method in which a precursor ion mass selection window is scanned across a mass range so that successive windows have large areas of overlap and small areas of non-overlap. This scanning makes the resulting product ions a function of the scanned precursor ion mass selection windows. This additional information is useful in identifying the one or more precursor ions responsible for each product ion, which is sometimes difficult to do in traditional SWATH.

One problem with scanning SWATH is that the level of data which is provided in the precursor ion m/z (Q1) dimension is limited by the speed of the precursor ion mass filter (Q1 quadrupole). This reduces the fidelity of the peak assignment but more importantly, in the case of scanning SWATH, it limits the definition of the precursor ion m/z which could have produced the various measured product ions. The algorithmic isolation of this precursor ion m/z requires a reasonable definition of the mass profile and, in many cases, there are just a limited number of data points across the precursor ion mass range.

As a result, there is a need for systems and methods that can increase the resolution of the scanning SWATH measurements in the precursor ion m/z dimension.

### Tandem Mass Spectrometry and Scanning SWATH

In general, tandem mass spectrometry, or MS/MS, is a well-known technique for analyzing compounds. Tandem mass spectrometry involves ionization of one or more compounds from a sample, selection of one or more precursor ions of the one or more compounds, fragmentation of the one or more precursor ions into product ions, and mass analysis of the product ions.

Tandem mass spectrometry can provide both qualitative and quantitative information. The product ion spectrum can be used to identify a molecule of interest. The intensity of one or more product ions can be used to quantitate the amount of the compound present in a sample.

A large number of different types of experimental methods or workflows can be performed using a tandem mass spectrometer. Three broad categories of these workflows are, targeted acquisition, information-dependent acquisition (IDA) or data-dependent acquisition (DDA), and data-independent acquisition (DIA).

In a targeted acquisition method, one or more transitions of a precursor ion to a product ion are predefined for a compound of interest. As a sample is being introduced into the tandem mass spectrometer, the one or more transitions are interrogated during each time period or cycle of a plurality of time periods or cycles. In other words, the mass spectrometer selects and fragments the precursor ion of each transition and performs a targeted mass analysis for the product ion of the transition. As a result, a mass spectrum is produced for each transition. Targeted acquisition methods include, but are not limited to, multiple reaction monitoring (MRM) and selected reaction monitoring (SRM).

In an IDA method, a user can specify criteria for performing targeted or untargeted mass analysis of product ions while a sample is being introduced into the tandem mass spectrometer. For example, in an IDA method, a precursor ion or mass spectrometry (MS) survey scan is performed to generate a precursor ion peak list. The user can select criteria to filter the peak list for a subset of the precursor ions on the peak list. MS/MS is then performed on each precursor ion of the subset of precursor ions. A product ion spectrum is produced for each precursor ion. MS/MS is repeatedly performed on the precursor ions of the subset of precursor ions as the sample is being introduced into the tandem mass spectrometer.

In proteomics and many other sample types, however, the complexity and dynamic range of compounds are very large. This poses challenges for traditional targeted and IDA methods, requiring very high-speed MS/MS acquisition to deeply interrogate the sample in order to both identify and quantify a broad range of analytes.

As a result, DIA methods, the third broad category of tandem mass spectrometry, were developed. These DIA methods have been used to increase the reproducibility and comprehensiveness of data collection from complex samples. DIA methods can also be called non-specific fragmentation methods. In a traditional DIA method, the actions of the tandem mass spectrometer are not varied among MS/MS scans based on data acquired in a previous precursor or product ion scan. Instead, a precursor ion mass range is selected. A precursor ion mass selection window is then stepped across the precursor ion mass range. All precursor ions in the precursor ion mass selection window are fragmented and all of the product ions of all of the precursor ions in the precursor ion mass selection window are mass analyzed.

Note that the terms “mass” and “mass-to-charge ratio (m/z)” can be used interchangeably. One of ordinary skill in the art understands that mass can be converted to m/z by dividing by the charge, and m/z can be converted to mass by multiplying by the charge. As a result, the use of the term “mass” should also include “m/z,” and the use of the term “m/z” should also include “mass.”

The precursor ion mass selection window used to scan the mass range can be very narrow so that the likelihood of multiple precursors within the window is small. This type of DIA method is called, for example, MS/MS^{ALL}. In an MS/MS^{ALL} method, a precursor ion mass selection window of about 1 amu is scanned or stepped across an entire mass range. A product ion spectrum is produced for each 1 amu precursor mass window. A product ion spectrum for the entire precursor ion mass range is produced by combining the product ion spectra for each mass selection window. The time it takes to analyze or scan the entire mass range once is referred to as one scan cycle. Scanning a narrow precursor ion mass selection window across a wide precursor ion mass range during each cycle, however, is not practical for some instruments and experiments.

As a result, a larger precursor ion mass selection window, or selection window with a greater width, is stepped across the entire precursor mass range. This type of DIA method is called, for example, SWATH acquisition. In a SWATH acquisition, the precursor ion mass selection window stepped across the precursor mass range in each cycle may have a width of 5-25 amu, or even larger. Like the MS/MS^{ALL} method, all the precursor ions in each precursor ion mass selection window are fragmented, and all of the product ions of all of the precursor ions in each mass selection window are mass analyzed. However, because a wider precursor ion mass selection window is used, the cycle time can be significantly reduced in comparison to the cycle time of the MS/MS^{ALL} method. Or, for liquid chromatography (LC), the accumulation time can be increased. Generally, for LC, the cycle time is defined by an LC peak. Enough points (intensities as a function of cycle time) must be obtained across an LC peak to determine its shape. When the cycle time is defined by the LC, the number of experiments or mass spectrometry scans that can be performed in a cycle defines how long each experiment or scan can accumulate ion observations. As a result, wider precursor ion mass selection window can increase the accumulation time.

U.S. Pat. No. 8,809,770 describes how SWATH acquisition can be used to provide quantitative and qualitative information about the precursor ions of compounds of interest. In particular, the product ions found from fragmenting a precursor ion mass selection window are compared to a database of known product ions of compounds of interest. In addition, ion traces or extracted ion chromatograms (XICs) of the product ions found from fragmenting a precursor ion mass selection window are analyzed to provide quantitative and qualitative information.

However, identifying compounds of interest in a sample analyzed using SWATH acquisition, for example, can be difficult. It can be difficult because either there is no precursor ion information provided with a precursor ion mass selection window to help determine the precursor ion that produces each product ion, or the precursor ion information provided is from a mass spectrometry (MS) observation that has a low sensitivity. In addition, because there is little or no specific precursor ion information provided with a precursor ion mass selection window, it is also difficult to determine if a product ion is convolved with or includes contributions from multiple precursor ions within the precursor ion mass selection window.

As a result, a method of scanning the precursor ion mass selection windows in SWATH acquisition, called scanning SWATH, was developed. Essentially, in scanning SWATH, a precursor ion mass selection window is scanned across a mass range so that successive windows have large areas of overlap and small areas of non-overlap. This scanning makes the resulting product ions a function of the scanned precursor ion mass selection windows. This additional information, in turn, can be used to identify the one or more precursor ions responsible for each product ion.

Scanning SWATH has been described in International Publication No. WO 2013/171459 A2 (hereinafter “the '459 Application”). In the '459 Application, a precursor ion mass selection window or precursor ion mass selection window of 25 Da is scanned with time such that the range of the precursor ion mass selection window changes with time. The timing at which product ions are detected is then correlated to the timing of the precursor ion mass selection window in which their precursor ions were transmitted.

The correlation is done by first plotting the mass-to-charge ratio (m/z) of each product ion detected as a function of the precursor ion m/z values transmitted by the quadrupole mass filter. Since the precursor ion mass selection window is scanned over time, the precursor ion m/z values transmitted by the quadrupole mass filter can also be thought of as times. The start and end times at which a particular product ion is detected are correlated to the start and end times at which its precursor is transmitted from the quadrupole. As a result, the start and end times of the product ion signals are used to determine the start and end times of their corresponding precursor ions.

FIG. 2 is a diagram 200 showing how a product ion produced from a precursor ion that is filtered by overlapping precursor ion mass selection windows in a scanning SWATH acquisition can be plotted as a function of the precursor ion mass selection window moving across the precursor mass range. Plot 210 shows that there is a precursor ion 220 at m/z 230. Precursor ion mass selection window 241 is stepped across the precursor ion mass range from m/z 231 to m/z 233, resulting in overlapping rectangular precursor ion mass selection windows 240. Each window of precursor ion mass selection windows 240 is fragmented. The resulting product ions are then mass analyzed, producing a product ion mass spectrum (not shown) for each window of precursor ion mass selection windows 240.

FIG. 2 shows just one scan of precursor ion mass selection window 241 across precursor ion mass range from m/z 231 to m/z 233. However, precursor ion mass selection window 241 can be scanned across precursor ion mass range from m/z 231 to m/z 233 multiple times, for example.

A product ion is selected from one of the product ion spectra produced. A product ion is selected, for example, that has a mass peak above a certain threshold.

The intensity of the product ion is then calculated as a function of the position of precursor ion mass selection window 241 by obtaining the intensity of the product ion from each product ion spectrum produced for each precursor ion mass selection window of precursor ion mass selection windows 240. The intensity of a selected product ion calculated as a function of the position of the precursor ion mass selection window can be called, for example, a quadrupole ion trace (QIT).

An exemplary QIT 260 calculated for a product ion is shown in plot 250. QIT 260 shows the intensities of the selected product ion obtained from each product ion spectrum produced for each precursor ion mass selection window of precursor ion mass selection windows 240. The intensities are plotted as a function of the leading edge of precursor ion mass selection windows 240. However, as described above, these intensities can be plotted as a function of any parameter of precursor ion mass selection windows 240 including, but not limited to, the trailing edge, set mass, leading edge, or scan time.

QIT 260 of plot 250 shows that the intensity of the selected product ion becomes non-zero when the leading edge of scanning precursor ion mass selection window 241 reaches m/z 230. It also shows that the intensity of the product ion returns to zero when the leading edge of the scanning precursor ion mass selection window passes m/z 232. In other words, QIT 260 has sharp leading and trailing edges corresponding to locations of scanning precursor ion mass selection window 241.

FIG. 2, shows that the leading and trailing edges of QIT 260 can be used to determine the corresponding precursor ion of the selected product ion. Essentially, the leading and trailing edges of QIT 260 mean that the precursor ion of the selected product ion must be in the precursor ion mass selection windows between these edges. Precursor ion mass selection windows 245 of precursor ion mass selection windows 240 have leading edges within these windows. Plot 210 shows that precursor ion 220 is the only precursor ion that can be in precursor ion mass selection windows 245. Therefore, the selected product ion with QIT 260 corresponds to precursor ion 220.

Scanning SWATH has also been described in U.S. Pat. No. 10,068,753 (hereinafter “the '753 Patent”). The '753 Patent improves the accuracy of the correlation of product ions to their corresponding precursor ions by combining product ion spectra from successive groups of the overlapping rectangular precursor ion mass selection windows. Product ion spectra from successive groups are combined by successively summing the intensities of the product ions in the product ion spectra. This summing produces a function that can have a shape that is non-constant with precursor mass. The shape describes product ion intensity as a function of precursor mass. A precursor ion is identified from the function calculated for a product ion.

FIG. 3 is diagram 300 showing how product ion spectra from successive groups of the overlapping rectangular precursor ion transmission windows are summed to produce a triangular function that describes product ion intensity as a function of precursor mass. Plot 310 shows that there is a precursor ion 320 at mass 330. Overlapping rectangular precursor ion transmission windows 340 are stepped across a mass range producing a plurality of product ion spectrum. Essentially, a product ion spectrum (not shown) is produced for each window 340.

Successive groups 350 of windows 340 are selected. The product ion intensities from spectra (not shown) from the successive groups 350 of windows 340 are summed. This summing produces plot 360. Plot 360 shows that a product ion of precursor ion 320 acquires a triangular-shaped function 370 of product ion intensity with respect to precursor mass. Plot 360 also shows that the apex or center of gravity of function 370 points to mass 330 of precursor ion 320.

In regard to the '459 Application, there are two problems with leading and trailing edge analysis of a QIT. First, as the '753 Patent describes, most mass filters are unable to produce precursor ion mass selection windows with sharply defined edges. As a result, a calculated QIT is likewise unlikely to have sharply defined edges. Secondly, the product ion may be a result of two or more different precursor ions that have similar masses. In other words, the product ion intensity may be a convolution of intensities produced from two or more interfering precursor ions. This problem also affects the summing technique of the '753 Patent.

FIG. 4 is a plot 400 of an exemplary quadrupole ion trace (QIT) calculated for a selected product ion that is produced from two interfering precursor ions using data from an actual scanning SWATH experiment. A comparison of plot 400 with plot 250 of FIG. 2 shows that an actual QIT does not have sharply defined edges. The comparison also shows the multiple levels of intensities caused by the two interfering precursor ions further complicates the determination of the corresponding precursor ions.

In response to the problems shown in FIG. 4, U.S. Pat. No. 10,651,019 (hereinafter “the '019 Patent”) is directed to determining a corresponding precursor ion from a product ion QIT using a system of linear equations. For example, each step of the precursor ion mass selection window across the mass range is represented by a linear equation. The unknown variables of each linear equation are the intensities of the precursor ion m/z values across the precursor ion mass range. The coefficients of each linear equation specify the position of the precursor ion mass selection window. The result of each equation is the value of the QIT at that particular step of the precursor ion mass selection window across the mass range. The corresponding precursor ions of a product ion QIT are found by solving the system of linear equations for the precursor ion intensity values across the precursor ion mass range (the unknown variables).

FIG. 5 is a diagram 500 showing a simplified example of how corresponding precursor ions are determined from a product ion QIT using a system of linear equations represented by a matrix multiplication equation. Plot 510 shows how precursor ion mass selection window 541 is scanned across a precursor ion mass range from an m/z of 1 to an m/z of 5. Precursor ions 521 and 522 are unknown.

A product ion is selected from the product ion spectra produced from scanning precursor ion mass selection window 541 across the precursor ion mass range from an m/z of 1 to an m/z of 5, fragmenting each window, and mass analyzing the product ions produced for each window. QIT 560 of plot 550 is the QIT calculated for the selected product ion. As described above, the actual QIT of the selected product ion will not have the sharp edges of QIT 560. In fact, the actual QIT of the selected product ion will look much more like QIT 410 of FIG. 4. However, QIT 560 is drawn with sharp edges to simplify the example.

In order to determine the precursor ions corresponding to QIT 560, a system of linear equations is calculated. This system is represented in the form of matrix multiplication equation 570. In equation 570, 9×5 mass filter matrix 571 is multiplied by precursor ion column matrix 572 of length 5 producing QIT column matrix 573 of length 9. The elements of mass filter matrix 571 are known from movements of precursor ion mass selection window 541 during the scan across the precursor ion mass range. QIT column matrix 573 is also known. It is calculated from the product ion spectra produced. Precursor ion column matrix 572 is unknown.

A numerical method is applied to matrix multiplication equation 570 to solve for precursor ion column matrix 572. The solution for precursor ion column matrix 572 determines the corresponding precursor ions for QIT 560. For example, the solution for precursor ion column matrix 572 shows that the selected product ion with QIT 560 was produced from a precursor ion with intensity 2 at 2 m/z and a precursor ion with intensity 1 at 3 m/z. These precursor ions are ions 521 and 522, respectively, shown in plot 510.

The '459 Application, the '753 Patent, and the '019 Patent provide methods for identifying one or more precursor ions corresponding to a product ion in scanning SWATH data. However, '459 Application, the '753 Patent, and the '019 Patent do not address reducing the file size needed to store scanning SWATH data without losing any information needed for post-processing of the data.

International Publication No. WO 2020/240506 A1 (hereinafter “the '506 Application”) does address reducing the file size needed to store scanning SWATH data. Specifically, as described in the '506 Application, each unique product ion detected is encoded in real-time during data acquisition. This encoding includes sums of counts or intensities of each unique ion detected the overlapping windows and positions of the windows associated with each sum. The encoding for each unique ion is stored in a memory device rather than the mass spectral data. A deblurring algorithm or numerical method is used to determine a precursor ion of each unique ion from the encoded data.

### SUMMARY

A system, method, and computer program product are provided for increasing the resolution of scanning SWATH data, in accordance with various embodiments. The system includes a mass spectrometer and a processor.

During each time cycle of a plurality of t time cycles, the mass spectrometer steps a precursor ion transmission window of fixed length/mass-to-charge ratio (m/z) in k overlapping steps that are Δm m/z apart entirely across a mass range r m/z (l<r) from a starting mₗ m/z of the mass range. The mass spectrometer steps the window n−1 more times across the mass range starting at n−1 different offsets from mₗ between mₗ and mₗ+Δm. As a result, n scans of the mass range and a total of k×n steps of the transmission window are produced for each time cycle. For each step of the transmission window, the mass spectrometer fragments the transmitted precursor ions and mass analyzes the resulting product ions. A total of k×n product ion spectra that are a function of precursor ion m/z are produced for each time cycle.

The processor selects at least one product ion from the k×n×t product ion spectra produced over the t time cycles. For at least one time cycle of the t time cycles, the processor reconstructs an intensity of the product ion as a function of precursor ion m/z with a resolving power greater than Δm. The processor performs the reconstruction by combining intensities of the product ion as a function of precursor ion m/z measured with a resolving power of Δm during each of the n scans for the time cycle using a linear reconstruction algorithm. These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is a diagram showing how a product ion produced from a precursor ion that is filtered by overlapping precursor ion mass selection windows in a scanning SWATH acquisition can be plotted as a function of the precursor ion mass selection window moving across the precursor mass range.

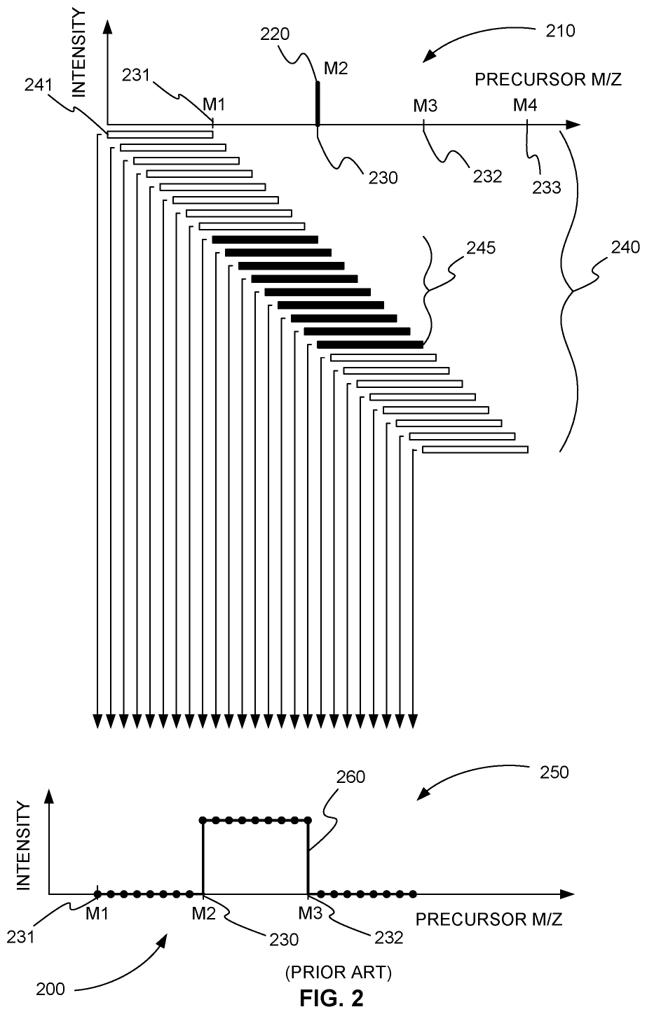

FIG. 3 is diagram showing how product ion spectra from successive groups of the overlapping rectangular precursor ion transmission windows are summed to produce a triangular function that describes product ion intensity as a function of precursor mass.

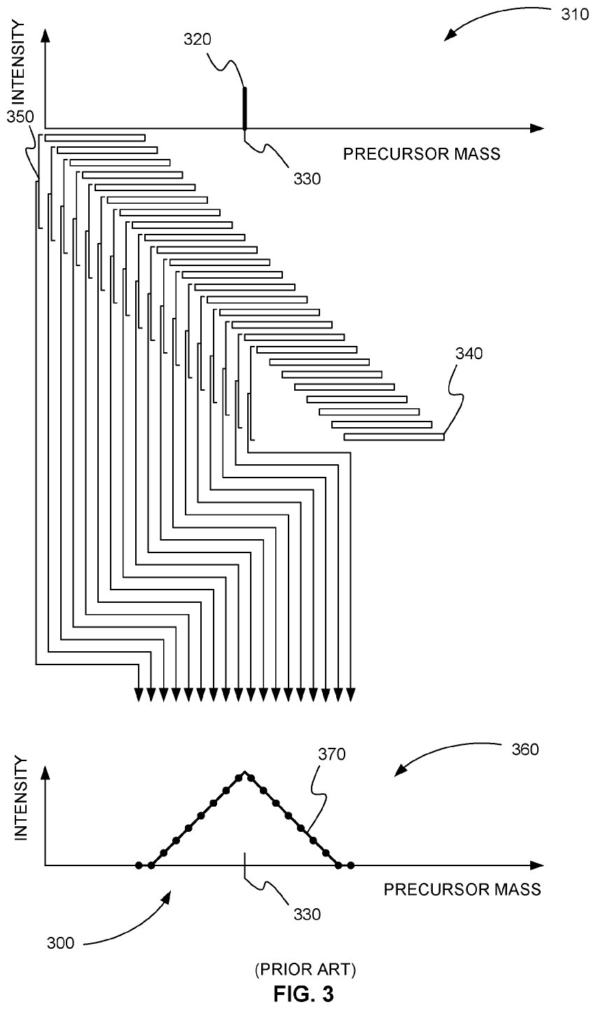

FIG. 4 is a plot of an exemplary quadrupole ion trace (QIT) calculated for a selected product ion that is produced from two interfering precursor ions using data from an actual scanning SWATH experiment.

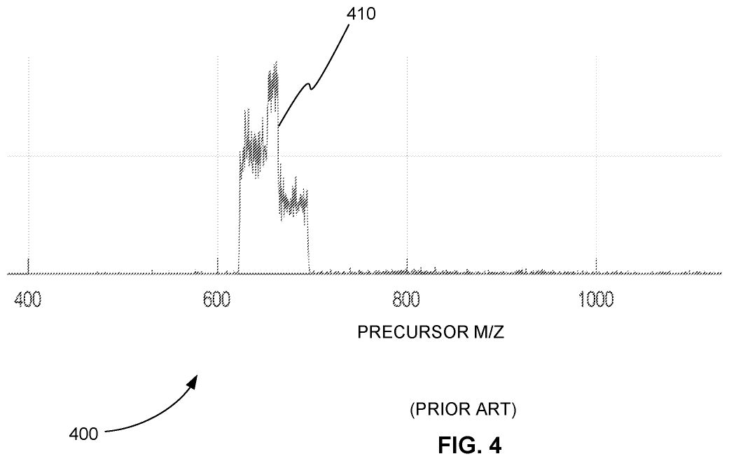

FIG. 5 is a diagram showing a simplified example of how corresponding precursor ions are determined from a product ion quadrupole ion trace (QIT) using a system of linear equations represented by a matrix multiplication equation.

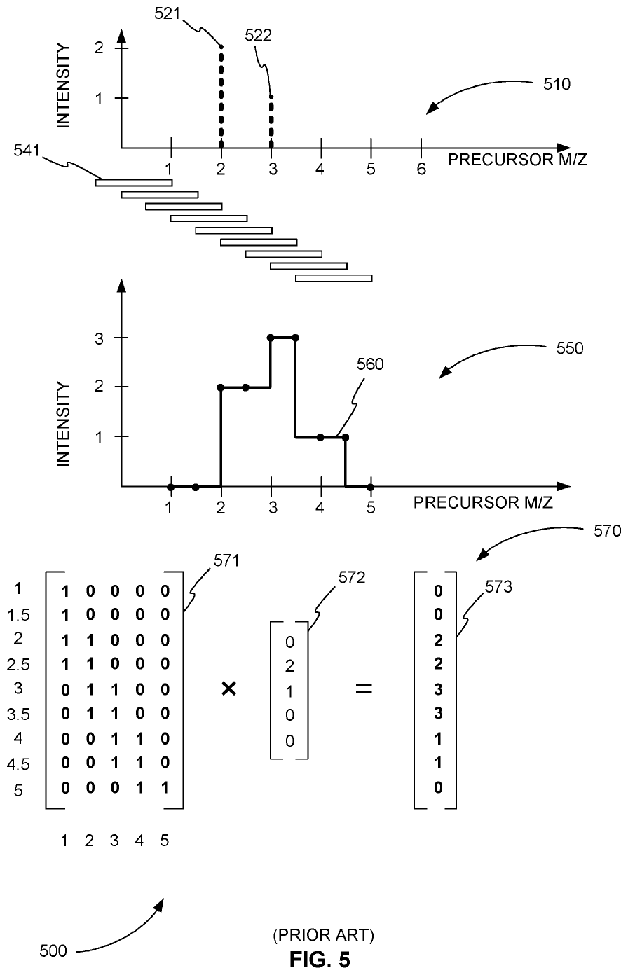

FIG. 6 is a schematic representation of the footprints of seven captured images covering a portion of a virtual image.

FIG. 7 is a schematic representation of a plurality of captured images covering a virtual image.

FIG. 8 is a schematic representation of drizzling, showing an association of an input pixel grid of a captured image with an array of smaller regions.

FIG. 9 is a schematic representation of drizzling, showing the mapping of an array of small regions of the captured image to corresponding pixels in the virtual image.

FIG. 10 is another schematic representation of drizzling, showing the mapping of an array of small regions of the captured image to corresponding pixels in the virtual image.

FIG. 11 is another schematic representation illustrating one example of resulting pixel magnitudes on a 3×3 pixel portion of the virtual image.

FIG. 12 is an exemplary diagram showing how a precursor ion mass window is scanned across a one-dimensional precursor ion mass range, in accordance with various embodiments.

FIG. 13 is an exemplary diagram showing how shrunken measured intensities of a product ion as a function of precursor ion m/z with a resolving power Δm are mapped to a reconstructed a measurement of the product ion as a function of precursor ion m/z with a resolving power greater than Δm using the Drizzle algorithm, in accordance with various embodiments.

FIG. 14 is a schematic diagram showing a system for increasing the resolution of scanning SWATH data in accordance with various embodiments.

FIG. 15 is a flowchart showing a method 1500 for increasing the resolution of scanning SWATH data, in accordance with various embodiments.

FIG. 16 is a schematic diagram of a system that includes one or more distinct software modules that perform a method for increasing the resolution of scanning SWATH data, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

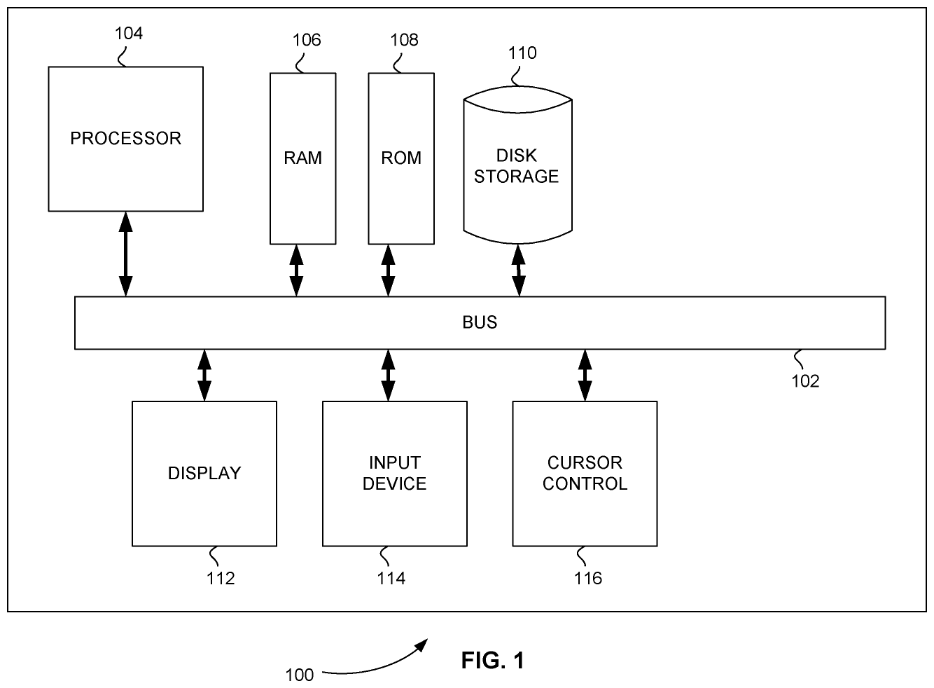

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively, hard-wired circuitry may be used in place of or in combination with software instructions to implement the present teachings. Thus, implementations of the present teachings are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and precursor ion mass selection media. Non-volatile media includes, for example, optical or magnetic disks, such as storage device 110. Volatile media includes dynamic memory, such as memory 106. Precursor ion mass selection media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Offset Scans and Linear Reconstruction

As described above, scanning SWATH is a tandem mass spectrometry method in which a precursor ion mass selection window is scanned across a mass range so that successive windows have large areas of overlap and small areas of non-overlap. One problem with scanning SWATH is that the level of data which is provided in the precursor ion mass-to-charge ratio (m/z) (Q1) dimension is limited by the speed of the precursor ion mass filter (Q1 quadrupole). This reduces the fidelity of the peak assignment but more importantly, in the case of scanning SWATH, it limits the definition of the precursor ion m/z which could have produced the various measured product ions.

As a result, there is a need for systems and methods that can increase the resolution of the scanning SWATH measurements in the precursor ion m/z dimension.

In various embodiments, the resolution of scanning SWATH measurements in the precursor ion m/z dimension is improved by offsetting a number of scanning SWATH scans during each time cycle and applying a linear reconstruction algorithm. Specifically, each scanning SWATH scan of a plurality of scanning SWATH scans is offset from the previous scan by an m/z increment. A linear reconstruction algorithm is then applied to the measurements of the plurality of scanning SWATH scans to improve the resolution of the measurements in the precursor ion m/z dimension.

In scanning SWATH, a high resolution in the precursor ion m/z dimension is desired but it often not attainable due to time constraints of the precursor ion mass filter. As a result, the precursor ion m/z dimension is typically under sampled.

Enhancement of resolution from an under sampled image is something that has plagued other disciplines for years. In the early 2000s, NASA developed a linear variable-pixel reconstruction algorithm (commonly referred to as the Drizzle algorithm) to enhance the under sampling effects of miss-matched CCD devices and optical telescopes. The Drizzle algorithm was originally applied to the Hubble telescope to assist with the data collection of the Hubble deep field and is now commonly used by many people on a global basis. Input to the algorithm is a series of images, which have a slightly shifted aspect or dither. The algorithm then provides enhanced pixel resolution by using linear interpolation of the input data. The Drizzle algorithm works with any arbitrary shift in the data, distortions in the data, and also with missing data.

In various embodiments, a scanning SWATH experiment is performed in a manner that allows for a shifting in the precursor ion m/z dimension. As a result, the resulting product ion intensities that are collected can then be processed using a Drizzle algorithm to enhance the precursor ion m/z resolution (i.e. the step size in the final data).

In various embodiments, the higher resolution data can be used in two ways. First, the higher precursor ion m/z resolution allows product ions to be deconvolved and assigned to their corresponding precursor ions with higher accuracy. Second, the higher precursor ion m/z resolution improves the conversion of the raw detector signal to an output SWATH file. Currently, raw detector measurements are stored using a binning approach. A measurement is assigned to a bin based on the likelihood that the product ion arrives in association with a precursor m/z. This association is governed by the width of the precursor ion mass window and its probable location in the precursor ion m/z dimension.

In various embodiments, a linear reconstruction algorithm such as the Drizzle algorithm is used to enhance the precursor ion mass window assignment of product ions. This enhanced assignment of product ions provides a significant increase in data quality.

The Drizzle algorithm is described in many references, including, for example, “Drizzle: A Method for the Linear Reconstruction of Undersampled Images,” Publication of the Astronomical Society of the Pacific 114: 114-152, February, 2002 (hereinafter “the Drizzle Paper”). The Drizzle paper outlines a family of techniques to restore image information lost to under sampling. This family of techniques is referred to as “linear reconstruction.”

A first linear reconstruction technique described in the Drizzle paper is interlacing. According to the Drizzle paper, in interlacing, “the pixels from the independent images are placed in alternating pixels on the output image according to the alignment of the pixel centers in the original images.” Due to telescope positioning errors or geometric distortion in the optics used, true interlacing may not be possible.

A second linear reconstruction technique described in the Drizzle paper is shift-and-add. According to the Drizzle paper, in shift-and-add, “a pixel is shifted to the appropriate location and then added onto a subsampled image.” The shift-and-add technique can handle the dither caused by telescope positioning errors or geometric distortion in the optics. However, because shift-and-add convolves the input image with the original pixel, the blurring of the image can be increased.

In response to the defects of interlacing and shift-and-add, the Drizzle paper proposes a third reconstruction technique referred to as variable pixel linear reconstruction, or more simply referred to as “Drizzle.” The Drizzle paper suggests that “Drizzle has the versatility of shift-and-add yet largely maintains the resolution and independent noise statistics of interlacing.”

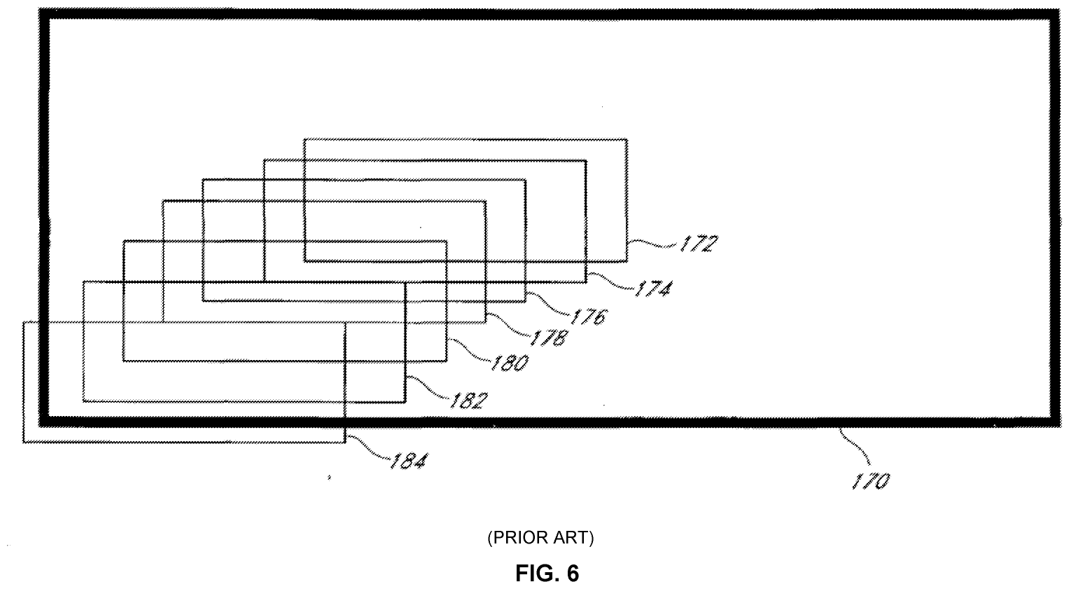

U.S. Patent Application Publication No. US 2006/0245640 A1 (hereinafter “the '640 Application”), for example, illustrates how Drizzle is used. FIG. 6 is a schematic representation of the footprints of seven captured images covering a portion of a virtual image. To capture images to cover all portions of the virtual image 170 of FIG. 6, the position parameter of a telescope can be adjusted to re-position the telescope after capturing an image so that a subsequent image includes at least a portion of the virtual image not captured by the previous image. FIG. 6 illustrates the footprint of a first captured image 172 captured at a first position that encompasses at least a portion of the virtual image 170. The first captured image 172 comprises pixels that correspond to pixels in the virtual image 170. FIG. 6 also illustrates footprints of images 174-184 which are captured after capturing the first image 172, where the telescope was repositioned to capture each of the images 174-184.

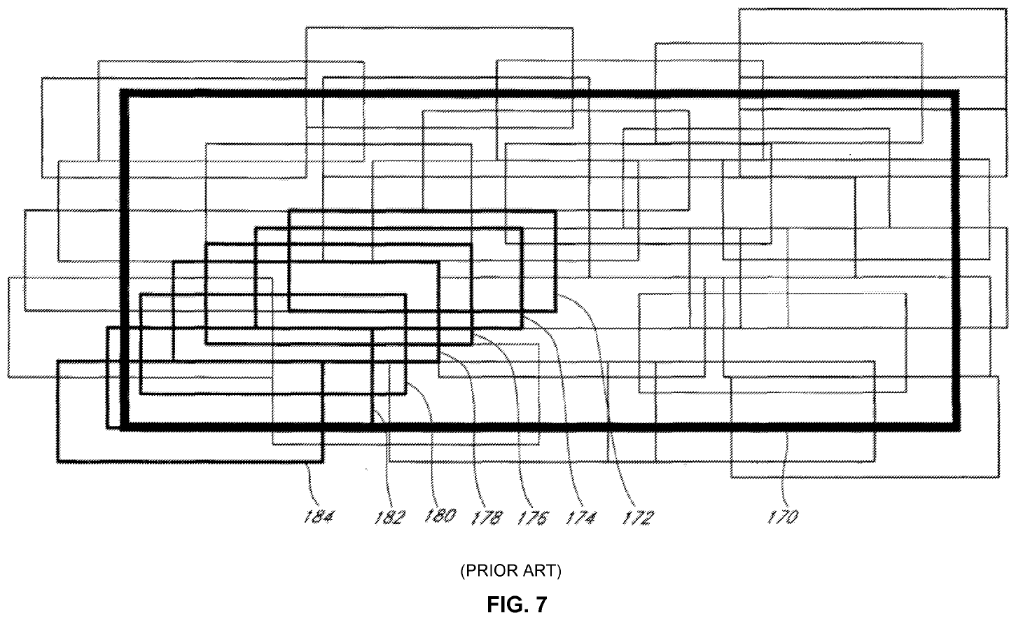

FIG. 7 is a schematic representation of a plurality of captured images covering a virtual image. FIG. 7 illustrates the footprints of images 174-184 and numerous other captured images covering the virtual image 170, where the image capturing is facilitated by repositioning the telescope on another portion of the virtual image 170. To form a complete composite image, one or preferably more than one image is captured corresponding to every pixel in the virtual image 170. The addition of multiple images over any one portion of the virtual image 170 increases the information that can be provided to the Drizzle algorithm for that portion of the area of interest. Using multiple images can result in a higher effective resolution and a reduction in correlated noise for the resulting composite image.

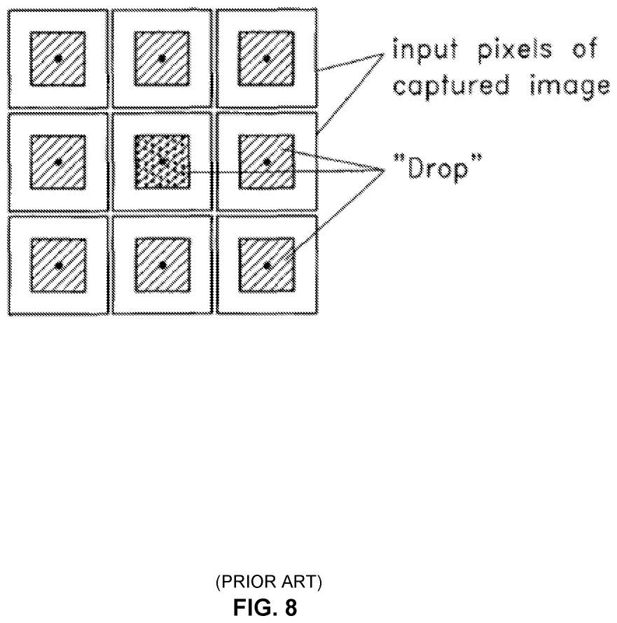

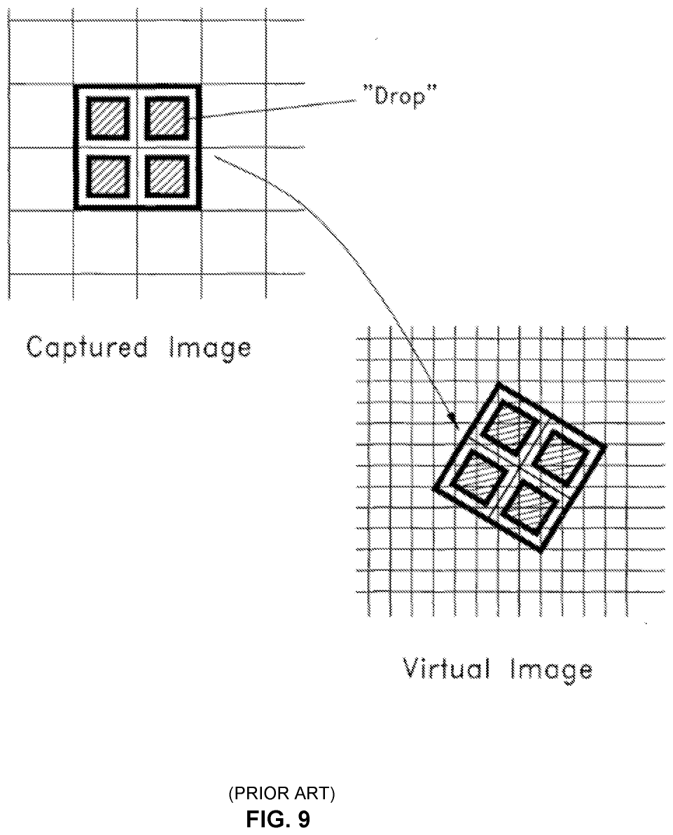

If the captured image has acceptable quality, the captured image 172 can be incorporated into the virtual image 170. Pixels of the virtual image 170 are then changed based on pixel magnitudes of the captured image using the Drizzle algorithm. In the Drizzle algorithm, pixels in the captured images (input images) are mapped into pixels in the virtual image, taking into account shifts and rotations between the images and the virtual image 170 as illustrated in FIGS. 8 and 9.

FIG. 8 is a schematic representation of drizzling, showing an association of an input pixel grid of a captured image with an array of smaller regions. FIG. 9 is a schematic representation of drizzling, showing the mapping of an array of small regions of the captured image to corresponding pixels in the virtual image.

Returning to FIG. 7, the pixels of the virtual image 170 are typically smaller than the pixels of the captured image. For example, the pixels in the virtual image 170 may be about one-half the size of the pixels in the captured images to about the size of the pixels in the captured images, although other values smaller than one-half the size of the pixels in the captured image are also possible. A higher resolution can therefore be obtained by mapping a plurality of captured images into the virtual image 170. To avoid convolving the image with the large pixel “footprint” of the detector array, the pixel is effectively “shrunk,” that is, the magnitude of the pixel in the captured image is associated with a smaller spatial region. This array of regions can also be referred to as shrunken pixels or as “drops.” FIG. 8 illustrates a 3 pixel by 3 pixel portion of a captured image and shows a drop defined for each pixel. As shown, the drop is smaller than the input pixel.

Magnitude values are associated with each of the drops. These magnitudes are distributed into a pixel in the virtual image. The association of the drops with one or more pixels in the virtual image is illustrated in FIG. 9. This association is based on the overlap of the drops with the pixels in the virtual image after the captured images have be shifted and/or rotated where appropriate. Reference features may be used to determine the suitable amount of translation and/or rotation. For example, the centroids of two reference points such as two stars may be used to compute the amount of shift in X and Y directions as well as the amount of rotation, the center of rotation, and the direction of rotation. One or both of these reference points may be changed, for example, in cases where the area of interest or the virtual image is so much larger than the captured images that some of the captured images do not include one or both the reference points. Other methods may also be employed.

As described above, the pixels in the virtual image are typically reduced in size in comparison with the pixels in the captured images. The pixels in the virtual image are also smaller than the drops. For example, the drops have linear dimensions one-half that of the input pixel, slightly larger than the dimensions of the pixels of the virtual image. The drops may range in size from between about one-fifth as large as the pixels in the captured images to the same size as the pixels in the captured images, and between about one and two times the size of the pixels in the virtual image. Values outside these ranges are also possible.

Portions of the magnitudes of the pixels of the captured image are distributed into the pixels of the virtual image based on the overlap of the drops (reduced regions) with the pixels of the virtual image. Accordingly, the drops may be said to “rain” down upon the corresponding pixels of the virtual image disposed underneath; hence the name “Drizzle.” For example, the pixel magnitude of each drop may be divided up among the overlapping virtual image pixels in proportion to the areas of overlap between the pixels of the virtual image and the drops of the captured image.

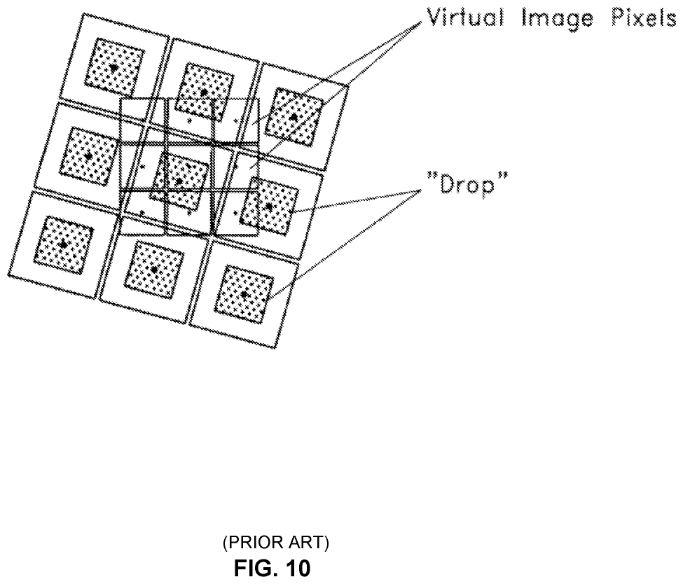

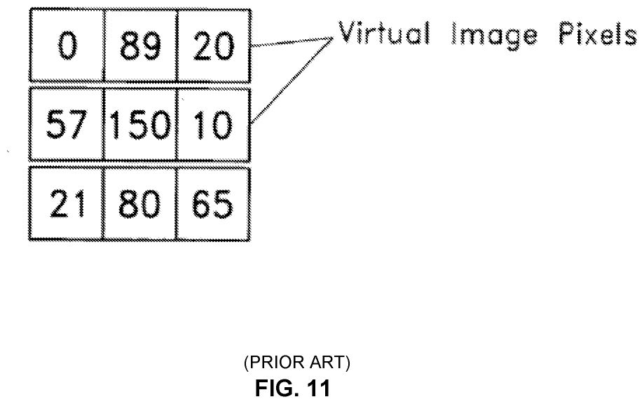

FIG. 10 is another schematic representation of drizzling, showing the mapping of an array of small regions of the captured image to corresponding pixels in the virtual image. FIG. 11 is another schematic representation illustrating one example of resulting pixel magnitudes on a 3×3 pixel portion of the virtual image.

FIG. 10 illustrates the resulting overlap between drops and pixels of the virtual image, where a 3 pixel by 3 pixel portion of the virtual image is shown overlaid on a 3 pixel by 3 pixel portion of captured image pixels. FIG. 11 illustrates one example of pixel magnitude values for the 3 pixel by 3 pixel portion of the virtual image shown in FIG. 10, where the magnitude values are based on values from 0-255 and correspond with the amount of overlap between the drops of the captured image and the pixels of the virtual image. These values are exemplary only and are not limiting. Note that if the drop size is too small not all output pixels in the virtual image have data added to them from each input image. One of the pixels in the virtual image shown in FIG. 10 has a zero value for this reason. Accordingly, the drop may be sized to be small enough to avoid degrading the image by convolution, yet large enough that after all images are “dripped,” the coverage is fairly uniform and not disrupted by zero values.

As described in the Drizzle paper, the “drop size is controlled by a user-adjustable parameter called pixfrac, which is simply the ratio of the linear size of the drop to the input pixel (before any adjustment due to the geometric distortion of the camera). Thus, interlacing is equivalent to Drizzle in the limit of pixfrac→0.0, while shift-and-add is equivalent to pixfrac=1.0.” In other words, depending on the pixfrac selected, Drizzle can be used to perform interlacing, shift-and-add, or variable pixel linear reconstruction. The pixfrac parameter can also be referred to as a fractional pixel overlap value.

In the Drizzle paper and the '640 Application, the Drizzle algorithm is applied to image pixels that extend two-dimensionally. Each image pixel has a magnitude, as described above.

In contrast, scanning SWATH data consists of one-dimensional measurements. Each measurement is a product ion intensity for a location of the precursor ion mass window. As a result, in various embodiments, the Drizzle algorithm is applied to intensity measurements that extend one-dimensionally.

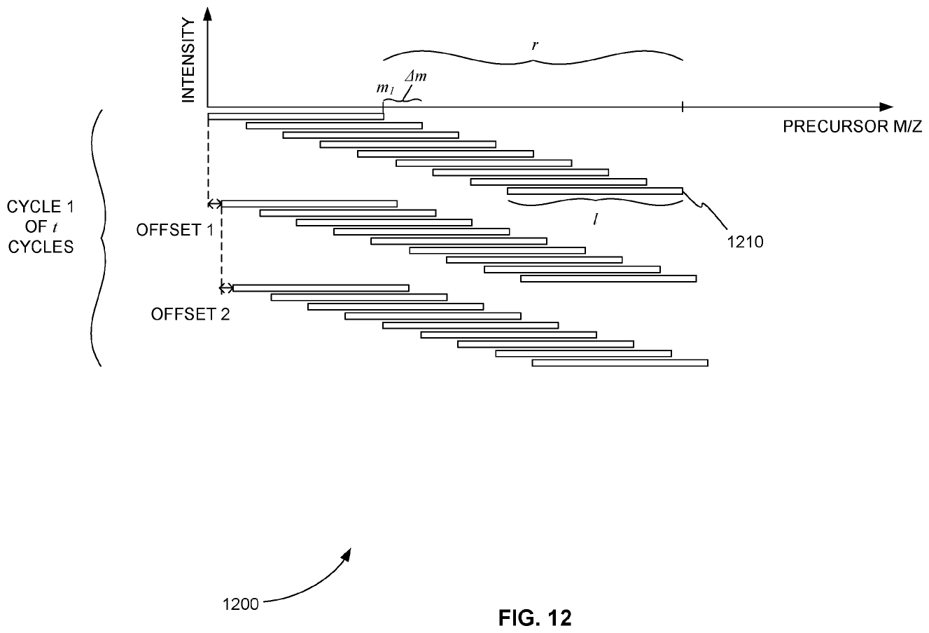

FIG. 12 is an exemplary diagram 1200 showing how a precursor ion mass window is scanned across a one-dimensional precursor ion mass range, in accordance with various embodiments. During each time cycle of a plurality of t time cycles, a precursor ion transmission window 1210 of fixed length l m/z is stepped in k overlapping steps that are Δm m/z apart entirely across a mass range r m/z (l<r). The leading edge, for example, of window 1210 starts at mₗ m/z of the mass range. Window 1210 is stepped eight times (k=8) in the example in FIG. 12.

In order to provide the dither required for the Drizzle algorithm, window 1210 is stepped n−1 more times starting at n−1 different offsets from mₗ between mₗ and mₗ+Δm. As shown in FIG. 12, window 1210 is stepped or scanned three times (n=3) across the mass range, using two offsets. A total of k×n steps of the transmission window are produced for each time cycle. For each step of window 1210, the transmitted precursor ions are fragmented and the resulting product ions are mass analyzed. This produces k×n product ion spectra that are a function of precursor ion m/z for each time cycle.

During each time cycle, the resolution of the intensity in the precursor ion m/z dimension of each product ion can be increased by using the n different scans that are offset from each other in the precursor ion m/z dimension as n different inputs to the Drizzle algorithm. For example, for at least one time cycle of the t time cycles, an intensity of at least one product ion as a function of precursor ion m/z is reconstructed with a resolving power greater than Δm by combining intensities of the product ion as a function of precursor ion m/z measured with a resolving power of Δm during each of the n scans for the one time cycle using Drizzle.

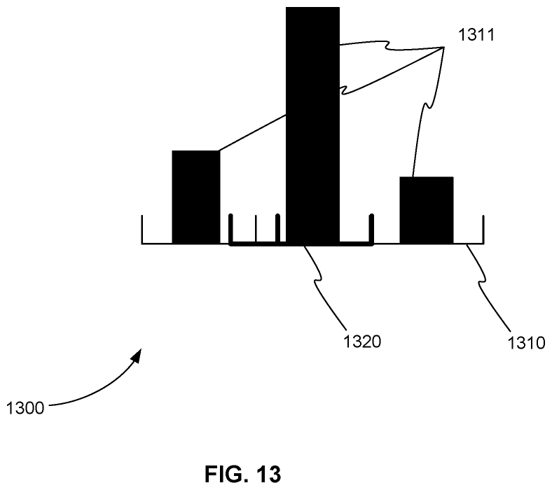

FIG. 13 is an exemplary diagram 1300 showing how shrunken measured intensities of a product ion as a function of precursor ion m/z with a resolving power Δm are mapped to a reconstructed measurement of the product ion as a function of precursor ion m/z with a resolving power greater than Δm using the Drizzle algorithm, in accordance with various embodiments. FIG. 13 illustrates the resulting overlap between shrunken measured intensities 1311 (drops) and bins (pixels) of the actual measurement 1310 and the reconstructed measurement 1320, where a three bin portion of the reconstructed measurement 1320 is shown overlaid on a three bin portion of the actual measurement 1310. FIG. 13 is, for example, a one-dimensional version of FIG. 10.

In various embodiments, the Drizzle algorithm can perform interlacing, shift-and-add, or variable pixel linear reconstruction to reconstruct a measurement of a product ion as a function of precursor ion m/z with a higher resolving power. As the Drizzle paper describes, nonuniform shifts can cause interlacing to become infeasible. As a result, interlacing can be performed only when the shifts or offsets in precursor ion mass windows between scans are uniform. Uniform offsets are shown in FIG. 12, for example. Similarly, shift-and-add or variable pixel linear reconstruction can be performed when the shifts or offsets in precursor ion mass windows between scans are nonuniform.

As described above, the '753 Patent suggests that most mass filters are unable to produce precursor ion mass selection windows with sharply defined edges like those shown in FIG. 12. As a result, shifts or offsets in precursor ion mass windows between scans may not be uniform even though a mass filter is instructed to provide such offsets for linear reconstruction. As a result, shift-and-add or variable pixel linear reconstruction are also useful algorithms for scanning SWATH.

In various embodiments, once an optimum drop size is found for a product ion, the reconstructed measurement of a product ion as a function of precursor ion m/z can be stored in a memory device rather than the mass spectral data for that product ion. As a result, Drizzle can also be used to encode each unique product ion detected, providing an alternative to the method of the '506 Application.

### System for Increasing the Resolution of Scanning SWATH Data

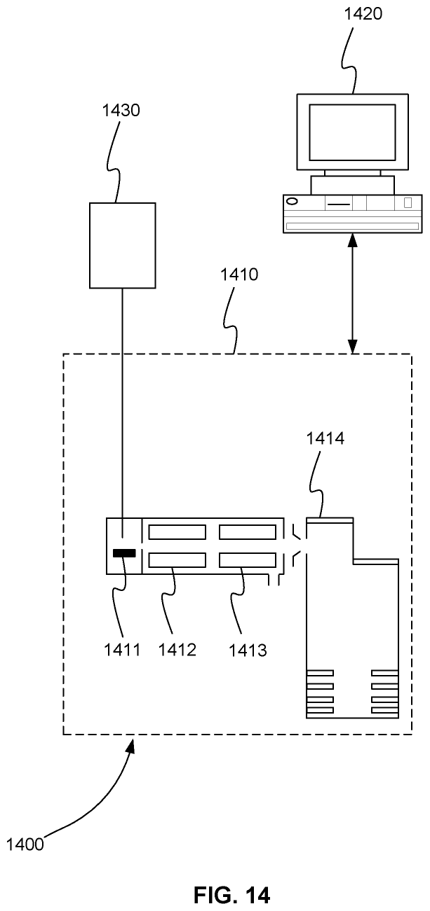

FIG. 14 is a schematic diagram 1400 showing a system for increasing the resolution of scanning SWATH data, in accordance with various embodiments. The system of FIG. 14 includes mass spectrometer 1410 and processor 1420.

Mass spectrometer 1410 can further include ion source 1411, mass filter 1412, fragmentation device 1413, and mass analyzer 1414, for example. In the system of FIG. 14, mass filter 1412 and fragmentation device 1413 are shown as different stages of a quadrupole and mass analyzer 1414 is shown as a time-of-flight (TOF) device. One of ordinary skill in the art can appreciate that any of these stages can include other types of mass spectrometry devices including, but not limited to, ion traps, orbitraps, ion mobility devices, or Fourier transform ion cyclotron resonance (FT-ICR) devices.

In various embodiments, the system of FIG. 14 can further include sample introduction device 1430. Sample introduction device 1430 introduces one or more compounds of interest from a sample to ion source device 1411 over time, for example. Sample introduction device 1430 can perform techniques that include, but are not limited to, injection, liquid chromatography, gas chromatography, capillary electrophoresis, or ion mobility.

During each time cycle of a plurality of t time cycles, mass spectrometer 1410 steps a precursor ion transmission window of fixed length/mass-to-charge ratio (m/z) in k overlapping steps that are Δm m/z apart entirely across a mass range r m/z (l<r) from a starting mₗ m/z of the mass range. Mass spectrometer 1410 steps the window n−1 more times across the mass range starting at n−1 different offsets from mₗ between mₗ and mₗ+Δm. As a result, n scans of the mass range and a total of k×n steps of the transmission window are produced for each time cycle. For each step of the transmission window, mass spectrometer 1410 fragments the transmitted precursor ions and mass analyzes the resulting product ions. A total of k×n product ion spectra that are a function of precursor ion m/z are produced for each time cycle.

Processor 1420 can be, but is not limited to, a computer, a microprocessor, the computer system of FIG. 1, or any device capable of sending and receiving control signals and data from mass spectrometer 1410 and processing data. Processor 1420 is in communication with mass spectrometer 1410. Processor 1420 is shown as a separate device but can be a processor or controller of mass spectrometer 1410 or another device.

Processor 1420 selects at least one product ion from the k×n×t product ion spectra produced over the t time cycles. For at least one time cycle of the t time cycles, processor 1420 reconstructs an intensity of the at least one product ion as a function of precursor ion m/z with a resolving power greater than Δm. Processor 1420 performs the reconstruction by combining intensities of the at least one product ion as a function of precursor ion m/z measured with a resolving power of Δm during each of the n scans for the at least one time cycle using a linear reconstruction algorithm.

In various embodiments, the linear reconstruction algorithm can be an interlacing algorithm, a variable-pixel reconstruction algorithm, or a shift-and-add algorithm.

In various embodiments, the interlacing algorithm can be a variable-pixel reconstruction algorithm with a fractional pixel overlap value of 0.

In various embodiments, the shift-and-add algorithm can be a variable-pixel reconstruction algorithm with a fractional pixel overlap value of 1.

In various embodiments, processor 1420 processor further identifies a precursor ion of the at least one product ion from the reconstructed intensity of the at least one product ion as a function of precursor ion m/z.

In various embodiments, processor 1420 processor further stores the reconstructed intensity of the at least one product ion as a function of precursor ion m/z in a memory device (not shown).

### Method for Increasing the Resolution of Scanning SWATH Data

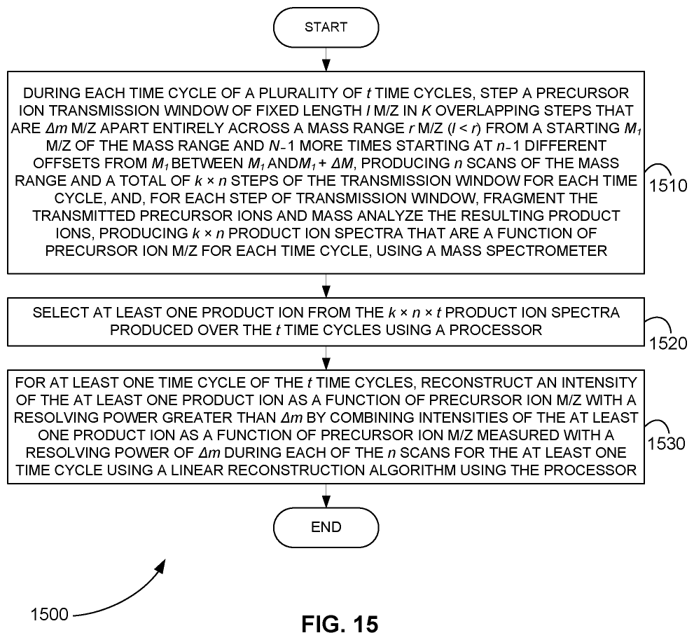

FIG. 15 is a flowchart showing a method 1500 for increasing the resolution of scanning SWATH data, in accordance with various embodiments.

In step 1510 of method 1500, during each time cycle of a plurality of t time cycles, a precursor ion transmission window of fixed length l m/z is stepped in k overlapping steps that are Δm m/z apart entirely across a mass range r m/z (l<r) from a starting mₗ m/z of the mass range using a mass spectrometer. The transmission window is stepped n−1 more times starting at n−1 different offsets from mₗ between mₗ and mₗ+Δm. A total of n scans of the mass range and a total of k×n steps of the transmission window are produced for each time cycle. For each step of the transmission window, the transmitted precursor ions are fragmented and the resulting product ions are mass analyzed. A total of k×n product ion spectra are produced that are a function of precursor ion m/z for each time cycle.

In step 1520, at least one product ion is selected from the k×n×t product ion spectra produced over the t time cycles using a processor.

In step 1530, for at least one time cycle of the t time cycles, an intensity of the at least one product ion as a function of precursor ion m/z is reconstructed with a resolving power greater than Δm. The reconstruction is performed by combining intensities of the at least one product ion as a function of precursor ion m/z measured with a resolving power of Δm during each of the n scans for the at least one time cycle using a linear reconstruction algorithm using the processor.

### Computer Program Product for Increasing the Resolution of Scanning SWATH Data

In various embodiments, computer program products include a tangible computer-readable storage medium whose contents include a program with instructions being executed on a processor so as to perform a method for increasing the resolution of scanning SWATH data. This method is performed by a system that includes one or more distinct software modules.

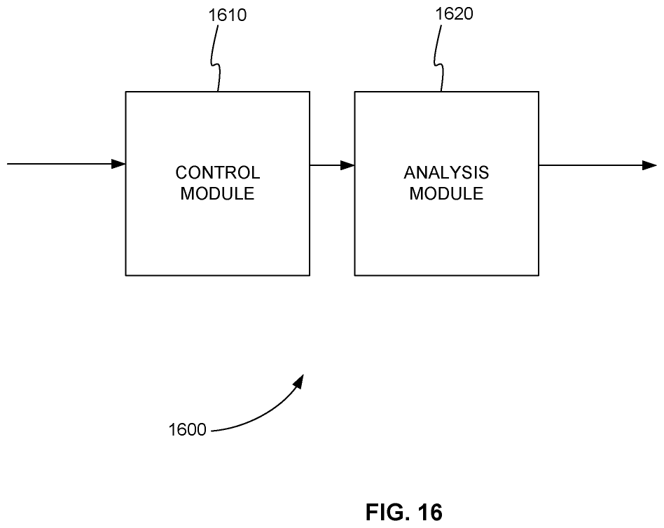

FIG. 16 is a schematic diagram of a system 1600 that includes one or more distinct software modules that perform a method for increasing the resolution of scanning SWATH data, in accordance with various embodiments. System 1600 includes a control module 1610 and an analysis module 1620.

Control module 1610 instructs a mass spectrometer to, during each time cycle of a plurality of t time cycles, step a precursor ion transmission window of fixed length l mass-to-charge ratio (m/z) in k overlapping steps that are Δm m/z apart entirely across a mass range r m/z (l<r) from a starting mₗ m/z of the mass range. Control module 1610 further instructs the mass spectrometer to step the transmission n−1 more times starting at n−1 different offsets from mₗ between mₗ and mₗ+Δm during the cycle. A total of n scans of the mass range and a total of k×n steps of the transmission window are produced for each time cycle. For each step of the transmission window, control module 1610 instructs the mass spectrometer to fragment the transmitted precursor ions and mass analyze the resulting product ions. A total of k×n product ion spectra are produced that are a function of precursor ion m/z for each time cycle.

Analysis module 1620 selects at least one product ion from the k×n×t product ion spectra produced over the t time cycles. For at least one time cycle of the t time cycles, analysis module 1620 reconstructs an intensity of the at least one product ion as a function of precursor ion m/z with a resolving power greater than Δm. The reconstruction is performed by combining intensities of the at least one product ion as a function of precursor ion m/z measured with a resolving power of Δm during each of the n scans for the at least one time cycle using a linear reconstruction algorithm.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A mass spectrometry system, comprising:
a mass spectrometer that, during each time cycle of a plurality of t time cycles, steps a precursor ion transmission window of fixed length l mass-to-charge ratio (m/z) in k overlapping steps that are Δm m/z apart entirely across a mass range r m/z (l<r) from a starting mₗ m/z of the mass range and n−1 more times starting at n−1 different offsets from mₗ between mₗ and mₗ+Δm, producing n scans of the mass range and a total of k×n steps of the transmission window for each time cycle, and, for each step of the transmission window, fragments the transmitted precursor ions and mass analyzes the resulting product ions, producing k×n product ion spectra that are a function of precursor ion m/z for each time cycle; and
a processor that
selects at least one product ion from the k×n×t product ion spectra produced over the t time cycles and
for at least one time cycle of the t time cycles, reconstructs an intensity of the at least one product ion as a function of precursor ion m/z with a resolving power greater than Δm by combining intensities of the at least one product ion as a function of precursor ion m/z measured with a resolving power of Δm during each of the n scans for the at least one time cycle using a linear reconstruction algorithm.

2. The system of claim 1, wherein the linear reconstruction algorithm comprises an interlacing algorithm.

3. The system of claim 2, wherein the interlacing algorithm comprises a variable-pixel reconstruction algorithm with a fractional pixel overlap value of 0.

4. The system of claim 1, wherein the linear reconstruction algorithm comprises a variable-pixel reconstruction algorithm.

5. The system of claim 1, wherein the linear reconstruction algorithm comprises a shift-and-add algorithm.

6. The system of claim 5, wherein the shift-and-add algorithm comprises a variable-pixel reconstruction algorithm with a fractional pixel overlap value of 1.

7. The system of claim 1, wherein the processor further identifies a precursor ion of the at least one product ion from the reconstructed intensity of the at least one product ion as a function of precursor ion m/z.

8. The system of claim 1, wherein the processor further stores the reconstructed intensity of the at least one product ion as a function of precursor ion m/z in a memory device.

9. A method of mass spectrometry, comprising:
during each time cycle of a plurality of t time cycles, stepping a precursor ion transmission window of fixed length l mass-to-charge ratio (m/z) in k overlapping steps that are Δm m/z apart entirely across a mass range r m/z (l<r) from a starting mₗ m/z of the mass range and n−1 more times starting at n−1 different offsets from mₗ between mₗ and mₗ+Δm, producing n scans of the mass range and a total of k×n steps of the transmission window for each time cycle, and, for each step of the transmission window, fragmenting the transmitted precursor ions and mass analyzing the resulting product ions, producing k×n product ion spectra that are a function of precursor ion m/z for each time cycle, using a mass spectrometer;
selecting at least one product ion from the k×n×t product ion spectra produced over the t time cycles using a processor; and
for at least one time cycle of the t time cycles, reconstructing an intensity of the at least one product ion as a function of precursor ion m/z with a resolving power greater than Δm by combining intensities of the at least one product ion as a function of precursor ion m/z measured with a resolving power of Δm during each of the n scans for the at least one time cycle using a linear reconstruction algorithm using the processor.

10. The method of claim 9, wherein the linear reconstruction algorithm comprises an interlacing algorithm.

11. The method of claim 9, wherein the linear reconstruction algorithm comprises a variable-pixel reconstruction algorithm.

12. The method of claim 9, wherein the linear reconstruction algorithm comprises a shift-and-add reconstruction algorithm.

13. The method of claim 9, further comprising identifying a precursor ion of the at least one product ion from the reconstructed intensity of the at least one product ion as a function of precursor ion m/z.

14. The method of claim 9, further comprising storing the reconstructed intensity of the at least one product ion as a function of precursor ion m/z in a memory device.

15. A computer program product, comprising a non-transitory tangible computer-readable storage medium whose contents include a program with instructions being executed on a processor for a mass spectrometry method, comprising:
providing a system, wherein the system comprises one or more distinct software modules, and wherein the distinct software modules comprise a control module and an analysis module;
instructing a mass spectrometer to, during each time cycle of a plurality of t time cycles, step a precursor ion transmission window of fixed length l mass-to-charge ratio (m/z) in k overlapping steps that are Δm m/z apart entirely across a mass range r m/z (l<r) from a starting mₗ m/z of the mass range and n−1 more times starting at n−1 different offsets from mₗ between mₗ and mₗ+Δm, producing n scans of the mass range and a total of k×n steps of the transmission window for each time cycle, and, for each step of the transmission window, fragment the transmitted precursor ions and mass analyze the resulting product ions, producing k×n product ion spectra that are a function of precursor ion m/z for each time cycle, using the control module;
selecting at least one product ion from the k×n×t product ion spectra produced over the t time cycles using the analysis module; and
for at least one time cycle of the t time cycles, reconstructing an intensity of the at least one product ion as a function of precursor ion m/z with a resolving power greater than Δm by combining intensities of the at least one product ion as a function of precursor ion m/z measured with a resolving power of Δm during each of the n scans for the at least one time cycle using a linear reconstruction algorithm using the analysis module.
